(19) United States
(12) Patent Application Publication
(10) Pub. No.: US 2025/0197733 A1
(43) Pub. Date: Jun. 19, 2025

(54) PROCESS FOR PRODUCING RENEWABLE HYDROCARBON FUEL FROM CRUDE BYPRODUCT OF ANIMAL WASTES FAT OIL BIODIESEL

(71) Applicant: COUNCIL OF SCIENTIFIC AND INDUSTRIAL RESEARCH, New Delhi (IN)

(72) Inventors: Arumugam Selvamani, Dehradun (IN); Nagabhatla Viswanadham, Dehradun (IN); Ray Anjan, Dehradun (IN); Tathod Anup Prakash, Dehradun (IN); Arumugam Sivasamy, Dehradun (IN); Kalarical Janardhanan Sreeram, Dehradun (IN)

(21) Appl. No.: 18/981,153

(22) Filed: Dec. 13, 2024

(30) Foreign Application Priority Data
Dec. 15, 2023 (IN) 202311086231

(51) Int. Cl. C10G 3/00

(52) U.S. Cl. CPC C10G 3/49; C10G 2300/1018; C10G 2300/305; C10G 2300/4006; C10G 2300/4012; C10G 2300/4018; C10G 2300/70; C10G 2400/30

(57) ABSTRACT

The present invention provides two types of low-value crude byproducts SOB and POB having various hydrocarbon contents i.e. huge amount of unconverted-TG,-FFA,-methanol along with -glycerol derived from slaughterhouses and poultry animal wastes fat oils biodiesel as novel bio-feedstocks for the production of C₅+ hydrocarbons, especially bio-aromatics. The method demonstrates a vapor phase catalytic process for the direct conversion of such crude byproducts 10 SOB and POB to produce bio-aromatics suitable renewable fuel application, over a versatile Zn/SBZ extrudate shape micro-mesoporous zeolite catalyst in a fixed bed reactor unit under mild reaction conditions. The method is also for increasing the overall economy of the biodiesel industries by converting their low-value crude byproducts into high-value fuel-grade hydrocarbons.

### FIELD OF THE INVENTION

The present invention relates to a process for producing renewable hydrocarbon fuel from crude byproduct of animal wastes fat oil biodiesel. In particular, the present invention relates to a one-step process for the production of aromatics-rich gasoline blend and H₂-rich fuel gases from the crude byproducts of the animal wastes fleshing-oil biodiesel. More particularly, the instant invention provides a simple vapor phase catalytic process for the production of gasoline range bio-aromatics from the novel low cost bio-feedstocks i.e. two types of raw crude byproducts viz., byproduct of slaughterhouses animal wastes oil biodiesel [SOB] and byproduct of poultry wastes oil biodiesel [POB] having various hydrocarbon contents such as huge amount of unconverted -TG, -FFA, -methanol along with -glycerol. The invention on one hand caters to the production of hydrocarbon fuel from alternate sources, while on the other helps in waste management. It shall help attain the 7^{th} and 12^{th} sustainable development goals of ‘affordable and clean energy’ and ‘responsible consumption and production’ respectively.

### BACKGROUND OF THE INVENTION AND DESCRIPTION OF PRIOR ART

The animal wastes fat oils obtained from slaughterhouses and poultry are considered as the highly potential triglyceride feedstocks for the production of biodiesel due to their surplus availability, chemical inertness, zero corrosivity, better calorific value and renewable nature. The biodiesel produced from such animal wastes fat oils is commonly known as second-generation biodiesel. However, a large volume of crude byproduct is generated (10-15 vol. %) in such animal wastes fat oils-based biodiesel process. The crude byproducts obtained from slaughterhouses wastes animal oil biodiesel and poultry wastes oil biodiesel are here named as SOB and POB, respectively. The formation of an extensive amount of such low-value crude byproducts in those biodiesel directly affects the biodiesel yield as well as the economy of the biodiesel industries.

The composition analysis results indicate that both crude byproducts SOB and POB consist of various hydrocarbon contents i.e. unconverted -triglycerides (TG), -free fatty acids (FFA), -methanol along with -glycerol in a different weight % as given in Table 1. The highly impure nature of those byproducts can significantly affect their practical applications. The separation of a component from these crude byproducts is considered an energy-intensive process which leads to affect its end-use economy. Due to these disadvantages, handling of those crude byproducts has become a big burden of biodiesel industries. However, the huge hydrocarbon contents and renewable nature of those crude byproducts can be considered as the potential features for their valorization process. Therefore, the bottom line of the present invention is to utilize such low value crude byproducts derived from above said animal wastes oils biodiesel without undergoing any purification treatments to produce valuable products.

TABLE 1
The hydrocarbon contents of crude byproducts SOB
and POB obtained from gas-chromatography analysis

| Compound (%) | SOB | POB |
|---|---|---|
| Glycerol | 65 | 71 |
| Methanol | 05 | 08 |
| Unconverted TG | 24 | 16 |
| Unconverted FFA | 06 | 05 |

Slaughterhouses waste animal oil byproduct (SOB)-Poultry oil byproduct (POB) obtained out of biodiesel processes carried out at Council of Scientific and Industrial Research-Central Leather Research Institute (CSIR-CLRI)

The most important transportation gasoline fuel, consisting of C₅+ hydrocarbons mainly aromatics, is typically produced from fossil resources. Due to the gradual depletion of fossil resources as well as an increase in demand for gasoline, the production of gasoline hydrocarbons from unconventional resources has become of great interest in the present scenario. Considering advantages such as surplus availability, chemical inertness, huge hydrocarbon contents, and renewable nature, the above-mentioned crude byproducts SOB and POB derived from above-said animal wastes fat oils biodiesel can be considered the potential renewable sources for the production of C₅+ hydrocarbons especially bio-aromatics. Therefore, the present invention attempted to utilize those byproducts for the production of valuable bio-aromatics useful for renewable fuel application.

Though, there are several reports available on the production of biodiesel or fuel hydrocarbons from animal wastes fat oil, no prior art reports available on the conversion of crude byproducts of animal fat oil biodiesel to produce bio-aromatics. In particular, no prior art report is available on the utilization of above said animal wastes fat oils biodiesel-derived byproducts SOB and POB for the production of bio-aromatics. However, some of the reports were available on the production of aromatics from bio-glycerol, but the glycerol reported in these reports was not been derived from above-said animal waste-derived oils, moreover, the glycerol used in these reports was purified and it does not contain any other hydrocarbon contents. These observations were revealed by the below given prior art reports.

Reference may be made to CN102154023 wherein hydrocarbon fuel was produced by a microwave-assisted catalytic soap decarboxylation process. The method comprises the following steps of: (1) adding alkali liquor and low-carbon alcohol to animal wastes fat or waste plant fat; (2) after saponification is ended, standing for demixing; (3) transferring fatty acid salt into a continuous type microwave cracking reactor; and (4) adding phosphoric acid in a glycerol layer obtained in the step (2) while stirring. This report deals with the conversion of waste animal fat or waste plant oil into fuel hydrocarbons, but not about the conversion of any byproduct formed during the biodiesel process to produce C₅+ hydrocarbons.

Reference may be made to CN113652272A wherein the invention discloses a preparation method and application of biodiesel and aviation fuel from animal oil via a transesterification route. However, the process does not deal with the conversion of any crude byproduct formed during the biodiesel process.

Reference may be made to WO2020141256A1 wherein the renewable base oil and other valuable renewable fuel components were produced from a feedstock of biological origin comprising free fatty acids and glycerides in presence of metal-acid bi-functional catalysts-platinum, and optionally heteropoly-acids (FIPA). The feedstock is first separated into two effluent streams comprising a fatty acid and glycerides. The obtained glycerides are hydrolyzed to free fatty acids and glycerol, further; the fatty acids are converted to the base oil, while the glycerol is converted to propanols.

Like the above reference, this report also deals with the conversion of fatty acid to fuels but it does not deal with the conversion of any byproduct of the biodiesel process.

Reference may be made to CN114350400A wherein the aromatic hydrocarbon and biochar produced by molten salt assisted pyrolysis of waste lignin using Zn loaded HZSM-5@SBA-15 catalyst. Therein, the Zn/HZSM-5@SBA-15 catalyst was employed for the valorization of waste lignin, but, this example does not deal with the conversion of any crude byproduct derived from biodiesel process. Further, this example reveals the molten salt prepared by melting a metal carbonate or a metal chloride salt to promote the catalytic activity of Zn/HZSM-5@SBA-15 in the production of aromatics from lignin. This example does not deal with any extrudate shape catalyst involving an inert binder. The preparation method of catalyst is also different from the present invention.

Reference may be made to WO2019062815A1 wherein the syngas was converted to para-xylene using metal functionalized core-shell type catalysts. Therein, the core material was HZSM-5, the shell selected from mesoporous material, preferably silicalite-1, and the metal function from Zn, Pt, Pd, Ga, etc. The preparation method and composition of core-shell catalysts are completely different from the present invention. Moreover, such core-shell catalyst was not applied for the conversion of any byproduct of the biodiesel process.

Reference may be made to CN113649059A wherein the aromatics compounds were produced from the pure glycerin over metal (Zn, Sn, Ag, Ga, Co) modified hollow-HZSM-5 catalysts. This reference discloses the production of aromatics from commercial-grade pure glycerin, but not from any raw crude byproduct of biodiesel process; especially this reference does not disclose the conversion of any crude byproducts derived from slaughterhouses animal fat oil and poultry animal oil.

Reference may be made to U.S. Pat. No. 20,150,336856A1 wherein the aromatics were produced from the pure glycerol over metal (Zn, Ga, Cu, Mo) modified HZSM-5 catalysts. It deals with the conversion of pure glycerol to produce aromatics. However, this reference does not deal with the conversion of any crude byproduct of the animal oil biodiesel process. The glycerol used for the reaction study has also not been derived from any above-said animal oils biodiesel process.

Reference may be made to V. Singh et al. (Conversion of bio-derived crude glycerol into renewable high-octane gasoline-stock, Vijendra Singh, Selvamani Arumugam,* Anup Prakash Tathod and Viswanadham Nagabhatla,* Chem. Commun., 2022, 58, 4873; and Efficient Bifunctional Catalysts for Enhanced Carbon Conversions and Alky-Aromatics Production in Crude Bio-glycerol Methanol Processes, Vijendra Singh, Selvamani Arumugam,* Anup Prakash Tathod, and Nagabhatla Viswanadham*, ACS Sustainable Chem. Eng. 2022, 10, 5323-5332) wherein the aromatics or gasoline stock were produced from the glycerol co-processed with external methanol using bi-metallic loaded ZSM-5 catalysts. In both reports, the commercial bio-glycerol having composition of 86% glycerol and 13% water and 1% ash has been used for the reaction studies. The glycerol feedstock used for the reaction studies in both cases has been commercially purchased from Merck, but it has not been directly taken from any biodiesel processes, especially it was not from slaughterhouses animal fat oil and poultry oil biodiesel processes. The glycerol feed reported in these both examples did not contain any other hydrocarbon contents like unconverted -TG or -FFA.

Reference may be made to Y. Xiao et al. (Conversion of Glycerol to Hydrocarbon Fuels via Bifunctional Catalysts, Yang Xiao and Arvind Varma, ACS Energy Lett. 2016, 1, 963-968) wherein the pure glycerol was converted into aromatic over noble-metals (Pt, Pd) loaded HZSM-5 catalysts. Therein, pure glycerol was used for the reaction study, and it does not contain any other hydrocarbon compounds. The catalysts used in this citation were different from present invention. Mainly, the source and composition of the glycerol used for the reaction studies have not been clearly mentioned; especially the glycerol used has not been derived from above said animal fat oils-based biodiesel processes.

Reference may be made to S. Tamiyakul et al. (Conversion of glycerol to aromatic hydrocarbons over Zn-promoted HZSM-5 catalysts, Sikarin Tamiyakul, Warayut Ubolcharoen, Duangamol N. Tungasmita, Siriporn Jongpatiwut,* Catalysis Today 256 (2015) 325-335) wherein the glycerol was converted into aromatic over Zn-promoted HZSM-5 catalysts. 99.99% pure glycerol was used for the reaction study, and it does not contain any other compounds. Mainly, the source of glycerol used in this reference has not been mentioned, especially which has not been derived from above said animal fat oils-based biodiesel processes.

### In Short, the Limitations of the Available Prior Art Can be Summarized as Follows:

Overall prior art reports clearly reveal that no report is available on the utilization of raw crude byproducts SOB and POB having various hydrocarbon contents such as unconverted -TG, -FFA, -methanol along with -glycerol which are derived from slaughterhouses animal wastes and poultry animal wastes fat oils biodiesel for the production of gasoline-range C₅+ hydrocarbons especially bio-aromatics. Though, some of the reports are available on the conversion of biodiesel-derived pure glycerol to produce aromatics, no report deals with the conversion of any crude byproduct of above-said animal wastes fat oils biodiesel, especially no report is available on the conversion of crude byproducts consisting of various hydrocarbon contents that are derived from slaughterhouses animal wastes oil and poultry animal wastes oil biodiesel to produce bio-aromatics.

It is well known that the chemical composition and nature of feedstock can significantly affect the aromatics product formation and its reaction pathways. Thus, prior art reports on the conversion of pure bio-glycerol to aromatics are not relevant to the present invention and such reported process also not suitable for the converting crude byproducts SOB and POB as they contain various hydrocarbon contents as impurities. Therefore, a completely different catalytic process is required for converting crude byproducts SOB and POB of above-said animal wastes oils biodiesel to produce gasoline range bio-aromatics. Moreover, all the prior art reports revealed that so far there is no report available for the conversion of above-said crude byproducts SOB and POB having different hydrocarbon contents to produce valuable bio-aromatics suitable for renewable gasoline blending application.

Hence, keeping in view the drawbacks of the hitherto reported prior art, the inventors of the present invention realized that there exists a dire need to provide a method for utilizing crude byproducts obtained from the biodiesel process of poultry and slaughterhouse wastes fleshing oils such as SOB and POB having various hydrocarbon contents viz., unconverted -TG, -FFA, -methanol along with -glycerol for the production of bio-aromatics via aromatization reaction without undergoing any purification treatments, wherein the process achieves 100% conversions of both crude-byproducts to produce 50-65 C % of C₅+ hydrocarbons liquid stock consisting of >80% aromatics, the liquid stock mainly possessing aromatics-rich hydrocarbons with high octane rating (RON>95) suitable for gasoline blending application; and wherein the C-C₄ (˜20 C %) and H₂ (˜25 mol %) gases formed as byproducts attract LPG and green fuel applications.

### OBJECTIVES OF THE INVENTION

The main objective of the present invention is therefore to provide a single-step vapor phase catalytic process operating on a versatile zeolite-based catalyst for the direct conversion of crude byproducts SOB and POB to produce gasoline range renewable C₅+ hydrocarbons especially aromatics useful for the gasoline blending application which obviates the drawbacks of the hitherto reported prior art.

Another objective of the present invention is to utilize two types of raw crude byproducts SOB and POB having various hydrocarbon contents such as unconverted -TG, -FFA, -methanol along with -glycerol obtained from the animal wastes (slaughterhouses and poultry) fat oils biodiesel processes as novel bio-feedstocks for the production of gasoline range bio-aromatics.

Yet another objective of the invention is to provide a process involving single-step vapor phase catalysis using versatile Zn-functionalized SBA-15 embedded ZSM-5 (Zn/SBZ) extrudate shape micro-mesoporous composite catalyst for the direct conversion of above-said raw crude byproducts SOB and POB feedstocks to produce bio-aromatics.

### SUMMARY OF THE INVENTION

In the present study, for the first time, crude byproducts SOB and POB consisting of unconverted -triglycerides (TG), -free fatty acids (FFA), -glycerol, and -methanol obtained from the slaughterhouses and poultry animal wastes fleshing oils biodiesel have been explored for the aromatization reaction without undergoing any purification treatments. The process achieved 100% conversions of both crude-byproducts to produce 50-65 C % of C₅+ hydrocarbon liquid stock consisting of >80% aromatics. The liquid stock mainly possessing aromatics-rich hydrocarbons with high octane rating (RON >95) is suitable for gasoline blending application. In addition, C₃-C₄ (˜20 C %) and H₂ (˜25 mol %) gases formed as byproducts attract LPG and green fuel applications.

Accordingly, the present invention provides a method for converting waste raw crude byproducts SOB and POB having various hydrocarbon contents (unconverted -TG, -FFA, -methanol along with -glycerol) collected from the above-said animal wastes fat oils biodiesel processes to produce gasoline range C₅+ hydrocarbons especially bio-aromatics useful for renewable gasoline blending applications.

In an embodiment, the present invention provides a single step vapor phase catalytic process for the direct conversion of such crude byproducts SOB and POB to produce bio-aromatics over a Zn-metal functionalized SBA-15 embedded ZSM-5 extrudate shape micro-mesoporous catalyst. Wherein, micropores of Zn/SBZ are suitable for diffusing the small glycerol/methanol molecules, while mesopores of Zn/SBZ are suitable for diffusing the long chain TG/FFA molecules present in the crude byproducts SOB and POB.

In another embodiment, the present invention provides a method for the preparation of a Zn/SBZ extrudate shape micro-mesoporous catalyst.

In still another embodiment, the present invention provides a single-step vapor phase catalytic process for the direct conversion of raw crude byproducts SOB and POB having various hydrocarbon contents to produce the bio-aromatics useful for gasoline blending application, in a fixed bed vapor phase reactor unit under mild reaction conditions.

In yet another embodiment, the present invention provides two types of crude byproducts SOB and POB having huge amount of unconverted -TG, -FFA, -methanol along with -glycerol collected from above-said animal wastes fat oils biodiesel, as the novel bio-feedstocks for the production of bio-aromatics, which is here reporting for the first time to best of our knowledge.

In still another embodiment, the present invention provides a process that exhibits almost 100% conversions of both byproducts SOB and POB mainly to produce bio-aromatics product.

In yet another embodiment, the present invention provides a SOB byproduct which produced 65C % liquid product consisting of C₅+ hydrocarbons mainly ˜85% aromatics with a research octane number of 105.

In still another embodiment of the present invention, the POB byproduct showed 58C % liquid product consisting of C₅+ hydrocarbons mainly ˜82% aromatics possessing research octane number of 97.

In yet another embodiment of the present invention, the SOB feedstock is relatively more suitable for the production of high yield of C₅+ hydrocarbon/aromatics product compared to the POB feedstock, which is probably due to the high hydrocarbon contents of the SOB feedstock than that of the POB feedstock.

In still another embodiment of the present invention, the liquid hydrocarbon product consists of high alkyl-aromatics (˜80%) with high octane number 97-105 produced from such crude byproducts in the present process attracts renewable gasoline blending application.

In yet another embodiment of the present invention, the high selectivity of alkyl-aromatics such as toluene and xylenes produced in present process attracts bio-petrochemicals and bio-polymers applications.

In still another embodiment of the present invention, the micro and mesopores of Zn/SBZ extrudate shape catalyst are suitable for diffusing the small glycerol/methanol molecules and long chain TG/FFA molecules, respectively.

In another embodiment of the present invention, the utilization of crude byproducts SOB and POB as novel feedstocks for the production of aromatics shows commercial benefits such as (i) reduce the aromatics imports in India, (ii) increase the overall economy of the biodiesel industry (iii) reduce the burden of handling surplus crude byproducts in the biodiesel industries and (iv) helps to utilize the domestic animal wastes to produce valuable bio-aromatics.

In a further embodiment, the present invention provides a single-step vapor phase catalytic process for the direct conversion of crude byproducts SOB and POB to produce bio-aromatics, over a Zn/SBZ extrudate shape catalyst in a fixed bed reactor unit under mild reaction condition, wherein the process comprising the steps of:
(a) loading extrudate shape Zn/SBZ catalyst into a fixed bed vapor phase reactor system and reducing the catalyst under a hydrogen gas flow;
(b) feeding the respective crude byproduct (SOB or POB) into the reactor with WHSV of 0.5 to 2.5 h⁻¹ at the reaction temperature of 370 to 480 degree C. in the pressure of 1 to 3 bar for 3 to 24 h under an N₂ gas atmosphere.

In another embodiment, the present invention provides a process, wherein feeding of the crude byproduct i.e. SOB or POB into the reactor is done at WHSV of 2.0 h⁻¹.

In still another embodiment, the present invention provides a process, wherein the reaction temperature is 395 degree C.

In yet another embodiment, the present invention provides a process, wherein the pressure is 2 to 3 bar.

In still another embodiment, the present invention provides a process, wherein ˜100% conversions of both SOB and POB byproducts towards various useful products namely aromatics and H₂-rich C₃-C₄ gases is achieved.

In yet another embodiment, the present invention provides a process, wherein the byproduct SOB produces C₅+ liquid hydrocarbons with the yield of 65C % mainly consisting of ˜85% aromatics possessing a research octane rating of 105.

In still another embodiment, the present invention provides a process, wherein the POB byproduct produces C₅+ liquid hydrocarbons with the yield of 58C % mainly consisting of ˜82% aromatics possessing a research octane rating of 97.

In yet another embodiment, the present invention provides a process, wherein the extrudate shaped Zn/SBZ catalyst comprises a binder (pseudo-boehmite), mesoporous creator (SBA-15) and microporous zeolite (ZSM-5), having both acidic and dehydrogenation function to facilitate the C₅+ hydrocarbons/aromatics production.

In still another embodiment, the present invention provides a process, wherein the Zn/SBZ extrudate shape catalyst possesses both micropores and mesopores.

### BRIEF DESCRIPTION OF THE ACCOMPANYING DRAWINGS

FIG. 1: N₂-adsorption-desorption isotherm of 1 wt. % Zn loaded SBA-15@ZSM-5 composite catalyst.

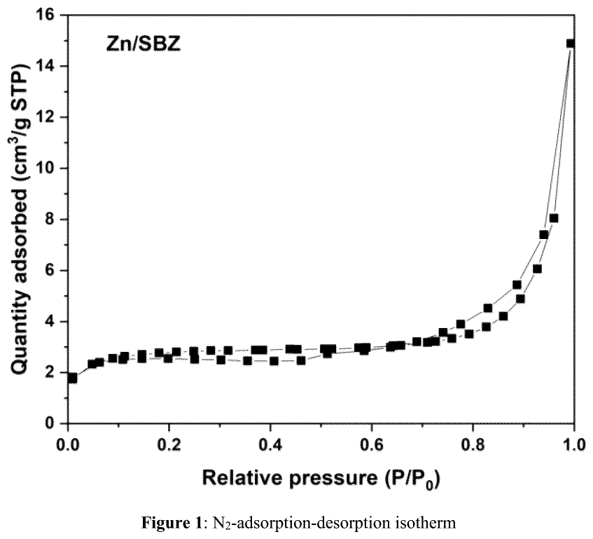

FIG. 2: NH₃-Temperature Programmed Reduction profile of 1 wt. % Zn loaded SBA-15@ZSM-5 composite catalyst.

FIG. 3: XRD result of 1 wt. % Zn loaded SBA-15@ZSM-5 composite catalyst.

### DETAILS OF BIOLOGICAL ESOURCES USED IN THE INVENTION

Slaughterhouses waste animal oil byproduct (SOB) and Poultry oil byproduct (POB) were obtained out of biodiesel processes carried out at Council of Scientific and Industrial Research-Central Leather Research Institute (CSIR-CLRI). The said SOB and POB byproducts were obtained from CSIR-CLRI, Adyar, Chennai, India.

### DETAILED DESCRIPTION OF THE INVENTION

The present invention provides a method for converting waste raw crude byproducts SOB and POB having various hydrocarbon contents such as huge amount of unconverted -TG, -FFA, -methanol along with -glycerol derived from the slaughterhouse wastes animal fat oil and poultry waste fat oil biodiesel to produce bio-aromatics suitable for renewable fuel application.

In an embodiment of the present invention is to provide single-step catalytic process for the direct conversion of crude byproducts SOB and POB to produce bio-aromatics towards renewable gasoline blending application, over a micro-mesoporous zeolite-based catalyst in a fixed bed vapor phase reactor unit under mild reaction conditions.

In an embodiment of the present invention is to provide a non-noble metal loaded zeolite-based (Zn/SBZ) extrudate shape micro-mesoporous material as a versatile catalyst comprising of microporous zeolite, mesoporous creator, binder and dehydrogenation metal function, for the direct conversion of above said raw crude byproducts SOB and POB to produce C₅+ hydrocarbons.

In an aspect of the present invention, the ZSM-5 having Si/Al=30-40 is selected from the microporous zeolite materials.

In another aspect of the present invention, the mesopores creator is selected from the silica materials, preferably SBA-15.

In yet another aspect of the present invention, the binder is an inert alumina, preferably pseudo-boehmite.

In still another aspect of the present invention, non-noble metal as a dehydrogenation function is selected from a transition metal, preferably Zn in different weight percentages from 1 to 5.

In a further aspect, the present invention provides a method for preparing Zn-functionalized SBA-15 embedded ZSM-5 extrudate shape composite (Zn/SBZ) catalyst, the preparation method comprises the following steps of;
preparing micro-mesoporous SBA-15@ZSM-5 (SBZ) composite as follows. Therein, adding 2-10 g of structural directing surfactant P123 to the 2-5 M hydrochloric acid and subject to vigorous stirring (300-500 rpm) for 3-6 h under ambient conditions to form a uniformly mixed sol. Then, adding ZSM-5 (5-10 g) powder and silica source (Tetraethyl orthosilicate, 4-10 g) to the above sol and stirring for 1-3 h continuously. Ageing of the resultant sol at ambient temperature for 18-24 h, then crystallizing the sol at 100-120° C. for 18-24 h followed by calcining at 480-550° C. for 3-6 h to get powder form SBA-15@HZSM-5 (SBZ) composite solid acid material.
preparing extrudate shape SBZ composite material by mixing above prepared SBZ composite powder with pseudo-boehmite binder in a weight ratio of 3:2 (SBA-15@ZSM-5 powder: pseudo-boehmite binder). Then adding required amount of peptizing reagent (3-5 vol. % glacial acetic acid) to support-binder mixture, and allowing it for ageing (6-12 h) to get a homogeneous paste. The making of extrudate shape SBZ catalyst from the support-binder mixture using a metallic hand extruder possessing pores in the size of 1-2 mm. Then drying the wet-extrudates at 100-120° C. for 8-12 h followed by calcining at 400-500° C. for 3-6 h. The prepared extrudate shape SBZ has a size of about 1-2 mm in diameter.
loading of Zn metal in different weight percentages (1-5 wt. %) to the prepared extrudate shape SBZ support by wet impregnation method. Wherein, Zn salt solution prepared by dissolving required amount of Zn(NO₃)₂·H₂O in double distilled water, and adding Zn-metal solution slowly to the extrudate shape SBZ. Then allowing it for ageing at ambient temperature for 6-12 h, and drying at 100-120° C. for 6-12 h followed by calcining at 400-550° C. for 4-6 h to get final extrudate shape Zn/SBZ composite catalysts.

In another aspect of the present invention, the Zn-loaded SBZ (Zn/SBZ) extrudate shape catalyst is a bi-functional possessing acid function and dehydrogenation metal function prepared by the above-said method.

In still another aspect of the present invention, the Zn/SBZ catalyst exhibits both micropores and mesopores.

In yet another aspect of the present invention, the pore volume of the Zn/SBZ catalyst is in the range of 0.35 cm³/g to 0.09 cm³/g, and the pore dimension is in the range of 2.6 nm to 9.5 nm.

In still another embodiment of the present invention, the optimum acidity is present in the prepared Zn/SBZ catalyst.

In yet another aspect of the present invention, Zn/SBZ exhibits a typical MFI zeolite structure.

In a proffered aspect, the present invention is directed to providing a single-step catalytic process for the direct conversion of two types of crude byproducts SOB and POB having various carbon contents derived from the above-mentioned animal wastes fat oils biodiesel to produce bio-aromatics useful for renewable fuel application, over a versatile Zn/SBZ extrudate shape micro-mesoporous catalyst in a vapor phase fixed bed reactor unit under mild reaction conditions. The catalytic process comprises the following steps of:
loading 2-5g extrudate shape Zn/SBZ catalyst into a fixed bed vapor phase reactor system, then, reducing the catalyst at 380-500° C. under a hydrogen gas flow of 5-10 L/h for 3-6 h, prior to the feed sending to the reactor.
feeding the respective crude byproduct (SOB or POB) into the reactor with WHSV (weight hourly space velocity) of 0.5-2.5 h-1 at the reaction temperature of 370-480° C. at 1-3 bar pressure for the reaction time of 3-24 h under N₂ gas atmosphere at a flow rate of 5-10 L/h.
condensing the product formed in the reactor by a cold circulating bath connected to a high-pressure liquid-gas separator, then analyzing the products by gas chromatography.

The process successfully utilized two types of crude byproducts SOB and POB possessing huge amount of unconverted—-TG, -FFA, -methanol along with -glycerol derived from slaughterhouses and poultry animal wastes fat oils biodiesel for the production of gasoline range bio-aromatics.

The process exhibits almost 100% conversions of both SOB and POB byproducts towards various useful products. Therein, the reaction study with SOB byproduct showed a 65C % yield of C₅+ hydrocarbon liquid product mainly consisting of ˜85% aromatics with a research octane number of 105. While, the reaction study with POB byproduct exhibited a 58C % yield of C₅+ hydrocarbon liquid product mainly possessing ˜82% aromatics with a research octane number of ˜97. The invention also revealed that SOB feedstock is relatively more suitable for the production of a high yield of C₅+ hydrocarbon liquid product compared to POB feedstock, which is probably due to the high hydrocarbon contents of SOB feedstock than that of POB feedstock.

As a result, the single-step vapor phase catalytic process for the production of C₅+ hydrocarbon liquid stock mainly containing aromatics from the SOB and POB byproducts over bi-functional Zn/SBZ extrudate shape micro-mesoporous catalyst, the process comprises the sequential steps of:
providing two types of crude byproducts SOB and POB as the novel bio-feedstocks for the production of renewable fuel range hydrocarbons.
providing the extrudate shape Zn/SBZ micro-mesoporous catalyst with 1-1.7 mm cross section and 2-2.8 mm length having the capacity of converting all the hydrocarbon contents of crude byproducts SOB and POB to produce fuel range hydrocarbons.
providing respective feedstock (SOB or POB) with a flow rate of WHSV 0.5-2.5 h-1.
providing a relatively mild reaction temperature of 370-480° C.
providing N₂-gas as a reaction atmosphere at the flow rate of 5-10 L/h.
providing reaction pressure of 1-3 bar.
providing the product details with the help of gas chromatography analysis.

The present invention describes a simple single-step catalytic process operating on a versatile extrudate shape micro-mesoporous Zn/SBZ catalyst for the direct conversion of raw crude byproducts SOB and POB possessing various hydrocarbon contents obtained from slaughterhouses and poultry animal wastes fat oils biodiesel to produce gasoline range renewable C₅+ hydrocarbons/aromatics, in a fixed bed vapor phase reactor unit under mild reaction conditions. In the present invention, the crude byproducts SOB and POB have been utilized as novel bio-feedstocks for the production of fuel range C₅+ renewable hydrocarbons, which is here reporting for the first time to the best of our knowledge. The present process showed almost 100% conversions of both byproducts SOB and POB towards various useful products. The C₅+ hydrocarbon liquid stock consisting of low benzene content (<3%) with maximum alkyl-aromatics having a research octane value of 97-105 makes advantages for its suitability for renewable gasoline blending application. The high concentration of alkyl-aromatics such as toluene and xylenes observed in the present invention attracts bio-petrochemicals and bio-polymers applications.

### EXAMPLES

The following examples are given by way of illustration only and therefore should not be construed to limit the scope of the present invention in any manner.

### Example 1

This example illustrates the preparation of SBA-15 modified ZSM-5 micro-mesoporous catalyst (SBZ) in powder form. Therein, ˜5 g of structural directing surfactant P123 was dissolved in the required amount of 2M hydrochloric acid and subjected to vigorous stirring (300-500 rpm) for 5 h under ambient conditions to form a uniformly mixed sol. Then, 12.12 g ZSM-5 powder and 10.7 g silica source (Tetraethyl orthosilicate) were added to the above sol and continuously stirred for 1 h, and the obtained sol was aged overnight at ambient temperature, then sol was crystallized at 110° C. for 18 h followed by calcined at 550° C. for 6 h to get powder form SBA-15@HZSM-5 (SBZ) composite support material.

### Example 2

The present example illustrates the preparation of an extrudate-shape SBZ catalyst by mixing the above-prepared SBZ composite powder with a pseudo-boehmite binder in a weight ratio of 3:2 (SBZ powder: pseudo-boehmite binder). Further, the required amount of 3 vol. % glacial acetic acid (peptizing reagent) was added to the SBZ support-binder mixture under constant stirring using a glass rod to get a homogeneous paste, and then the paste mixture was allowed for peptization for 8 h at ambient temperature. The resultant paste was used for making extrudates using a metallic hand extruder having a pore diameter of ˜2 mm. Then, the formed extrudate was dried at 120° C. for 10 h followed by calcined at 500° C. for 5 h.

### Example 3

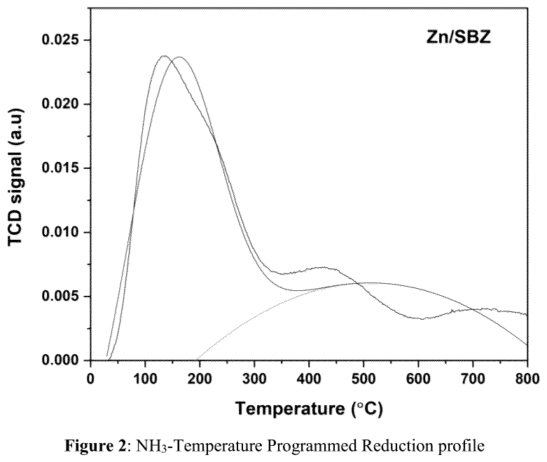

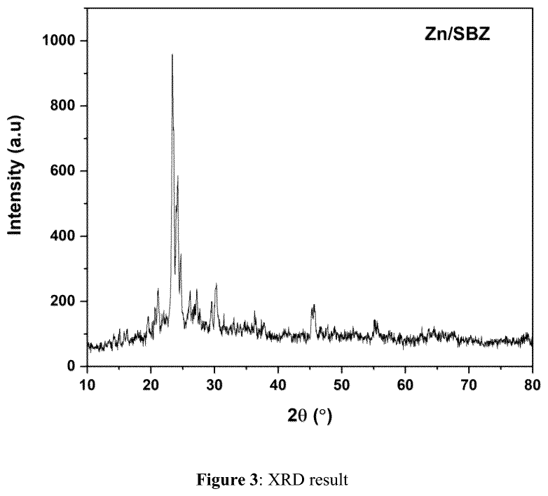

This example discloses the preparation of Zn-metal (1 wt. %) loaded SBZ extrudate shape catalyst by wet impregnation method. Therein, the solution of Zn metal salt is prepared by dissolving a calculative amount of Zn(NO₃)₂·H₂O salt in the required amount of double distilled water. Then Zn-metal solution was slowly added to the extrudate shape SBZ solid support, and allowed it for ageing overnight at ambient temperature, and the obtained sample was dried at 120° C. for 6 h followed by calcined at 450° C. for 4 h to get final extrudate shape Zn/SBZ composite catalyst. The physico-chemical properties of prepared catalyst material have been studied with various characterization methods. N₂-adsorption-desorption isotherm result of Zn/SBZ indicate a combination of type I isotherm at low pressure and type IV isotherm at high pressure which are assigned to the micropores and mesopores, respectively. As shown in Table 2, the Zn/SBZ showed a surface area of about ˜538 m²/g, a pore volume of about ˜0.09 cm³, and an average pore dimension of about ˜8 nm. The NH₃-TPD profile of Zn/SBZ catalyst shown in FIG. 2 illustrates two distinguished desorption peaks; the first intense desorption peak at ˜150° C. is a characteristic of weak acid sites, and the second small desorption peak at ˜410° C. is assigned to the strong acid sites. In the XRD result (FIG. 3), the Zn/SBZ sample exhibited various diffraction peaks mainly at 2θ=7°-9° (two peaks) and 20=23°-25° (three peaks), related to the crystalline MFI zeolite structure. No diffraction peaks were observed due to the Zn and SBA-5 moieties indicating structure of ZSM-5 remained constant even after adding Zn and SBA-15 moieties to ZSM-5 support. Overall characterization results reveal the successful formation of Zn-functionalized SBA-15@ZSM-5 (Zn/SBZ) composite catalyst possessing special catalytic features such as micro-mesopores and sufficient acidity suitable for promoting aromatization reaction.

TABLE 2
The pore textural properties of 1 wt. % Zn loaded SBA-15@ZSM-5
composite catalyst obtained from N₂-adsorption-desorption analysis

| | Property | | |
|---|---|---|---|
| | Surface area | Pore volume | Pore diameter |
| Catalyst | (m²/g) | (cm³/g) | (nm) |
| Zn/SBZ | 538 | 0.09 | ~8 |

### Example 4

This example illustrates the direct conversion of the crude SOB feedstock to produce fuel-range C₅+ hydrocarbons/aromatics over Zn/SBZ extrudate shape catalyst at the various reaction temperatures in a vapor phase fixed bed reactor setup. Therein, 3 g of extrudate shape Zn/SBZ catalyst was loaded into a reactor, and then it was reduced at 450° C. under a hydrogen gas flow of 7 L/h for 4 h. The crude SOB feedstock was then fed into the reactor at the various reaction temperatures of 370° C., 395° C. and 480° C., maintaining other reaction parameters constantly

(WHSV—2 h⁻¹, pressure—2 bar, time—6 h, and N₂ gas flow rate—7 L/h). The product formed in the reactor was condensed by a cold circulating bath connected to a high-pressure liquid-gas separator. The product formed in the process was analyzed by a gas chromatography method. The obtained results revealed that the conversion of SOB feedstock, and liquid product yield and aromatics selectivity were high at the reaction temperature of 395° C. However, the reaction studies conducted with other two reaction temperature of 370° C. and 480° C. showed poor conversion and liquid product yield. This result indicates the reaction temperature of 395° C. is the optimum one for achieving the highest conversion (˜100%) of SOB feedstock to produce C_{5+—}hydrocarbon liquid product (65C %) consisting of maximum aromatics (85%) with research octane number of 105 (Table 3).

TABLE 3
Effect of temperature on reaction

| | Temperature (° C.) | | | | | |
|---|---|---|---|---|---|---|
| | 370 | | 395 | | 480 | |
| | Feedstock | | | | | |
| | SOB | POB | SOB | POB | SOB | POB |
| Conversion (%) | 88.0 | 87.0 | 98.0 | 99.0 | 100 | 100 |
| Liquid product yield (C %) | 56.0 | 50.0 | 65.0 | 58.0 | 52.0 | 51.0 |

Liquid product distribution (%)

| | | | | | | |
|---|---|---|---|---|---|---|
| (i) Aromatics (%) | 78.0 | 76.0 | 85.0 | 82.0 | 83.0 | 80.0 |
| C₆ | 1.4 | 1.5 | 1.5 | 2.7 | 1.2 | 1.2 |
| C₇ | 14.0 | 18.0 | 15.8 | 17.4 | 15.8 | 17.9 |
| C₈ | 38.6 | 35.0 | 41.0 | 38.6 | 39.8 | 37.4 |
| C₉ | 13.5 | 12.5 | 14.7 | 12.8 | 13.7 | 12.5 |
| C₁₀⁺ | 10.5 | 9.0 | 12.0 | 10.5 | 12.5 | 11.0 |
| (ii) Non-Aromatics (%) | 22.0 | 24.0 | 15.0 | 18.0 | 17.0 | 20.0 |
| Total (i + ii) | 100 | 100 | 100 | 100 | 100 | 100 |
| RON | 94 | 93 | 105 | 97 | 100 | 97 |

Reaction conditions: catalyst - Zn/SBZ, catalyst weight - 3 g, WHSV - 2 h⁻¹, pressure - 2 bar, time - 6 h.

### Example 5

The present example illustrates the direct conversion of the crude SOB feedstock to produce fuel-range C₅+ hydrocarbons/aromatics over Zn/SBZ extrudate shape catalyst at various WHSV in a vapor phase fixed bed reactor setup. Therein, 3 g of extrudate shape Zn/SBZ catalyst was loaded into a reactor, and then it was reduced at 450° C. under a hydrogen gas flow of 7 L/h for 4 h. The crude SOB feedstock was then fed into the reactor with various WHSV of 0.5 h⁻¹, 2 h⁻¹ and 2.5 h⁻¹ at the reaction temperature of 395° C. and 2 bar pressure for the reaction time of 6 h under N2 gas at a flow rate of 7 L/h. The product formed in the process was analyzed by a gas chromatography method. The obtained results reveal that the conversion of SOB feedstock, liquid product yield and aromatics selectivity were high at WHSV of 2 h⁻¹, compared to the reaction studies at other WHSV of 0.5 h⁻¹ and 2.5 h⁻¹. This result indicates the WHSV of 2 h⁻¹ is the optimum one for achieving the highest conversion (˜100%) of SOB feedstock to produce C₅+ hydrocarbon liquid product (65C %) consisting of maximum aromatic (85%) with research octane number of 105 (Table 4).

TABLE 4
Effect of WHSV on reaction

| | WHSV (h⁻¹) | | | | | |
|---|---|---|---|---|---|---|
| | 0.5 | | 2.0 | | 2.5 | |
| | Feedstock | | | | | |
| | SOB | POB | SOB | POB | SOB | POB |
| Conversion (%) | 85.0 | 84.0 | 98.0 | 99.0 | 92.0 | 93.0 |
| Liquid product yield (C %) | 52.0 | 45.0 | 65.0 | 58.0 | 63.0 | 50.0 |

Liquid product distribution (%)

| | | | | | | |
|---|---|---|---|---|---|---|
| (i) Aromatics (%) | 68.0 | 66.0 | 85.0 | 82.0 | 78.0 | 75.0 |
| C₆ | 1.4 | 1.7 | 1.5 | 2.7 | 1.5 | 1.2 |
| C₇ | 11.5 | 13.0 | 15.8 | 17.4 | 15.2 | 16.3 |
| C₈ | 34.6 | 32.8 | 41.0 | 38.6 | 37.5 | 35.4 |
| C₉ | 12.0 | 10.5 | 14.7 | 12.8 | 12.8 | 11.5 |
| C₁₀⁺ | 8.5 | 8.0 | 12.0 | 10.5 | 11.0 | 10.6 |
| (ii) Non-Aromatics (%) | 32.0 | 34.0 | 15.0 | 18.0 | 22.0 | 25.0 |
| Total (i + ii) | 100 | 100 | 100 | 100 | 100 | 100 |
| RON | 82 | 80 | 105 | 97 | 93 | 92 |

Reaction conditions: catalyst - Zn/SBZ, catalyst weight - 3 g, temperature - 395° C., pressure - 2 bar, time - 6 h.

### Example 6

This example illustrates the direct conversion of the crude SOB feedstock to produce fuel-range C₅+ hydrocarbons/aromatics over Zn/SBZ extrudate shape catalyst at various reaction pressures in a vapor phase fixed bed reactor setup. Therein, 3 g of extrudate shape Zn/SBZ catalyst was loaded into a reactor, and then it was reduced at 450° C. under a hydrogen gas flow of 7 L/h for 4 h. The crude SOB feedstock was then fed with WHSV of 2 h⁻¹ into the reactor at the various pressure of 1 bar, 2 bar and 3 bar, keeping other reaction conditions constantly (temperature—395° C., reaction time—6 h, N₂ flow rate—7 L/h). The product formed in the process was analyzed by a gas chromatography method. The obtained results reveal that the conversion of SOB feedstock, liquid product yield and aromatics selectivity were almost similar at all three reaction pressure 1 bar, 2 bar and 3 bar (Table 5).

TABLE 5
Effect of pressure on reaction

| | Reaction pressure (bar) | | | | | |
|---|---|---|---|---|---|---|
| | 1 | | 2 | | 3 | |
| | Feedstock | | | | | |
| | SOB | POB | SOB | POB | SOB | POB |
| Conversion (%) | 97.0 | 99.0 | 98.0 | 99.0 | 98.0 | 99.0 |
| Liquid product yield (C %) | 64.5 | 57.0 | 65.0 | 58.0 | 64.8 | 57.5 |

Liquid product distribution (%)

| | | | | | | |
|---|---|---|---|---|---|---|
| (i) Aromatics (%) | 84.5 | 82.0 | 85.0 | 82.0 | 85.0 | 81.0 |
| C₆ | 1.4 | 2.6 | 1.5 | 2.7 | 1.8 | 2.5 |
| C₇ | 15.5 | 17.5 | 15.8 | 17.4 | 16.0 | 18.0 |
| C₈ | 41.3 | 37.0 | 41.0 | 38.6 | 40.5 | 39.5 |
| C₉ | 14.5 | 13.5 | 14.7 | 12.8 | 14.7 | 12.6 |
| C₁₀⁺ | 11.8 | 11.4 | 12.0 | 10.5 | 12.0 | 8.4 |
| (ii) Non-Aromatics (%) | 15.5 | 18.0 | 15.0 | 18.0 | 15.0 | 19.0 |
| Total (i + ii) | 100 | 100 | 100 | 100 | 100 | 100 |
| RON | 105 | 97 | 105 | 97 | 104 | 97 |

Reaction conditions: catalyst - Zn/SBZ, catalyst weight - 3 g, temperature - 395° C., WHSV - 2 h⁻¹, time - 6 h.

### Example 7

This example illustrates the direct conversion of crude POB feedstock derived from the poultry animal wastes fat oil biodiesel to produce fuel-range C₅+ hydrocarbons/aromatics over extrudate shape Zn/SBZ catalyst in a vapor phase fixed bed reactor setup. Therein, the experimental procedure and reaction conditions were the same as mentioned in the Example 4-6 except for using SOB feed. The product formed in the process was also analyzed by a gas chromatography method and obtained result is given in Table 3-5. The result given in Table 3-5 clearly indicates that SOB feedstock is relatively more suitable for the production of a high yield of C₅+ hydrocarbon liquid product compared to POB feedstock, which is probably due to the high hydrocarbon contents of SOB feedstock than that of POB feedstock.

### ADVANTAGES OF THE INVENTION

The present invention provides two types of low-value crude byproducts SOB and POB having various hydrocarbon contents such as huge amount of unconverted -TG, -FFA, -methanol along with -glycerol derived from slaughterhouses and poultry animal wastes fat oils biodiesel as novel bio-feedstocks for the production of gasoline range renewable hydrocarbons.
The developed process is simple single-step vapor phase catalytic process capable of directly converting such crude byproducts SOB and POB to produce valuable aromatics useful for renewable fuel and petrochemical applications.
A versatile Zn/SBA extrudate shape catalyst possessing micro-mesopores is provided here for converting various sizes of hydrocarbons to produce fuel range aromatics.
The liquid hydrocarbon products formed in the present study consists of >80% alkyl-aromatics with research octane number in the range of 97-105 are suitable for high octane gasoline blending application.
The high selectivity of toluene and xylene isomers in the formed aromatics attracts bio-petrochemicals and bio-polymers applications.

We claim:

1. A single-step vapor phase catalytic process for the direct conversion of crude byproducts SOB and POB to produce bio-aromatics, over a Zn/SBZ extrudate shape catalyst in a fixed bed reactor unit under mild reaction condition, wherein the process comprising the steps of:
(a) loading extrudate shape Zn/SBZ catalyst into a fixed bed vapor phase reactor system and reducing the catalyst under a hydrogen gas flow;
(b) feeding the respective crude byproduct (SOB or POB) into the reactor with WHSV of 0.5 to 2.5 h⁻¹ at the reaction temperature of 370 to 480 degree C. in the pressure of 1 to 3 bar for 3 to 24 h under an N₂ gas atmosphere.

2. The process as claimed in claim 1, wherein feeding of the crude byproduct i.e. SOB or POB into the reactor is done at WHSV of 2.0 h⁻¹.

3. The process as claimed in claim 1, wherein the reaction temperature is 395 degree C.

4. The process as claimed in claim 1, wherein the pressure is 2 to 3 bar.

5. The process as claimed in claim 1, wherein ˜100% conversions of both SOB and POB byproducts towards various useful products namely aromatics and H₂-rich C₃-C₄ gases is achieved.

6. The process as claimed in claim 1, wherein the byproduct SOB produces C₅+ liquid hydrocarbons with the yield of 65C % mainly consisting of ˜85% aromatics possessing a research octane rating of 105.

7. The process as claimed in claim 1, wherein the POB byproduct produces C₅+ liquid hydrocarbons with the yield of 58C % mainly consisting of ˜82% aromatics possessing a research octane rating of 97.

8. The process as claimed in claim 1, wherein the extrudate shaped Zn/SBZ catalyst comprises a binder (pseudo-boehmite), mesoporous creator (SBA-15) and microporous zeolite (ZSM-5), having both acidic and dehydrogenation function to facilitate the C₅+ hydrocarbons/aromatics production.

9. The process as claimed in claim 1, wherein the Zn/SBZ extrudate shape catalyst possesses both micropores and mesopores.
